(19) United States
(12) Patent Application Publication
(10) Pub. No.: US 2015/0288048 A1
(43) Pub. Date: Oct. 8, 2015

(54) INKJET OR PEN BASED PRINTED PERIODIC DIRECTORS FOR MILLIMETER-WAVE LINKS ON FLEXIBLE SUBSTRATES

(71) Applicant: CALIFORNIA INSTITUTE OF TECHNOLOGY, Pasadena, CA (US)

(72) Inventors: Adrian J. Tang, Pasadena, CA (US); Goutam Chattopadhyay, Pasadena, CA (US); Choonsup Lee, La Palma, CA (US); Emmanuel Decrossas, Pasadena, CA (US); Nacer E. Chahat, Pasadena, CA (US)

(21) Appl. No.: 14/678,751

(22) Filed: Apr. 3, 2015

Related U.S. Application Data
(60) Provisional application No. 61/974,898, filed on Apr. 3, 2014.

(51) Int. Cl. H01P 3/00; H01P 11/00; H01Q 1/50

(52) U.S. Cl. CPC H01P 3/00; H01Q 1/50; H01P 11/003

(57) ABSTRACT

A data link, comprising a substrate; and an ink structure printed and/or marked on a substrate, wherein the structure directs an electric, magnetic, and/or electromagnetic wave between two locations.

### CROSS-REFERENCE TO RELATED APPLICATIONS

This application claims the benefit under 35 U.S.C. Section 119(e) of co-pending and commonly assigned U.S. Provisional Application No. 61/974,898, filed Apr. 3, 2014, by Adrian J. Tang, Goutam Chattopadhyay, Choonsup Lee, Emmanuel Decrossas, and Nacer E. Chahat, entitled “INKJET OR PEN BASED PRINTED PERIODIC DIRECTORS FOR MM-WAVE LINKS ON FLEXIBLE SUBSTRATES”, client reference number CIT-6822-P2, which application is incorporated by reference herein.

### STATEMENT REGARDING FEDERALLY SPONSORED RESEARCH AND DEVELOPMENT

The invention described herein was made in the performance of work under a NASA contract, and is subject to the provisions of Public Law 96-517 (35 U.S.C. §202) in which the Contractor has elected to retain title.

### BACKGROUND OF THE INVENTION

1. Field of the Invention

This invention relates to the field of telecommunication, and in particular, signal directors and data links.

2. Description of the Related Art (Note: This application references a number of different publications as indicated throughout the specification by one or more reference numbers within brackets, e.g., [x]. A list of these different publications ordered according to these reference numbers can be found below in the section entitled “References.” Each of these publications is incorporated by reference herein.)

Previous work on dielectric waveguides with periodic directors examined confining an electric/magnetic field closer to the waveguide to avoid generating channel cross-talk and interfering radiation. However, these previous periodically directed waveguides were implemented on complex substrates (e.g. Rogers™ Duroid™ and high-density polyethylene, HDPE), which are all semi-rigid and relatively expensive substrates (see, e.g. [1]). Furthermore, the process of patterning these waveguides on substrates such as printed circuit boards (PCB) require the time-consuming and costly processes of creating protective masks and etching the desired patterns. While looking for an approach to implement such periodically directed waveguides on flexible substrates, one or more embodiments of the present invention developed an approach using an applied liquid metal or metal ink.

### SUMMARY OF THE INVENTION

To overcome the limitations in the prior art described above, and to overcome other limitations that will become apparent upon reading and understanding the present specification, the present invention discloses a data link, comprising a substrate; and an ink structure printed and/or marked on a substrate, wherein the structure (e.g., periodic director) directs one or more electric, magnetic, and/or electromagnetic waves or Electromagnetic (EM) radiation between two locations.

The EM radiation or waves can comprise millimeter (mm) waves (e.g., having a wavelength in a range of 1-10 mm), microwaves, Terahertz radiation, or waves having a terahertz frequency.

The substrate can be an insulating and/or flexible substrate, and/or comprise at least one material selected from a fabric, cloth, cardboard, wood, plastic, rubber, ceramic, glass, leather, composite, paper, concrete, textile, and carpet.

The data link can further comprise a transmitter that transmits the EM radiation or waves comprising data to the structure; and a receiver that receives the EM radiation directed by the structure.

The EM radiation or waves can carry data comprising voice, text, video, image, and/or internet data between the two locations.

The structure can direct the EM radiation or waves carrying data between one or more devices selected from one or more mobile devices, a display, and a computer.

The ink can comprise a composition (e.g., metal) and the structure comprises one or more dimensions suitable to direct the EM radiation or waves.

One or more embodiments of the invention further disclose a method for propagating EM radiation or the waves, comprising transmitting EM radiation or the waves to an ink-based metallic structure printed on the substrate, wherein the structure directs EM radiation between two locations.

One or more embodiments of the invention further disclose a method for fabricating a data link, comprising printing a structure on a substrate using ink from an ink printer comprising a processor, wherein the ink has a composition comprising metal and the structure is dimensioned to direct EM radiation or the waves between two locations.

Other objects, features and advantages of the present invention will become apparent to those skilled in the art from the following detailed description. It is to be understood, however, that the detailed description and specific examples, while indicating some embodiments of the present invention are given by way of illustration and not limitation. Many changes and modifications within the scope of the present invention may be made without departing from the spirit thereof, and the invention includes all such modifications.

### BRIEF DESCRIPTION OF THE DRAWINGS

Referring now to the drawings in which like reference numbers represent corresponding parts throughout:

FIG. 1 shows a setup illustrating the propagation of a signal across a series of ink-based metallic strips drawn with a metallic pen on a cardboard surface, in accordance with one or more embodiments of the present invention.

FIGS. 2A and 2B show various embodiments of a system for propagating a signal, comprising a transmitter, a receiver, and a periodic director structure comprising a series of ink-based metallic strips.

FIG. 3 shows a system for propagating a signal where the periodic director structure comprising a series of ink-based metallic lines are printed on a person's clothing as well as on the floor, in accordance with one or more embodiments of the present invention, wherein signals are propagated along the metallic lines between a cellular phone in the person's pocket, a watch (e.g., smart watch), and glasses, and are also propagated to/from the floor.

FIG. 4 shows an embodiment of the system for propagating a signal where a series of ink-based metallic lines are printed on a table, in accordance with one or more embodiments of the present invention, wherein signals are propagated along the metallic lines between a mobile device and a projector on the table.

FIG. 5 is a flowchart illustrating a method of fabricating a data link, according to one or more embodiments of the invention.

FIG. 6 is a flowchart illustrating a method of propagating EM radiation, according to one or more embodiments of the invention.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Technical Description

The inventors found that using a metallic ink to print a periodic structure on a variety of materials (e.g. cardboard, leather, plastics, paper, and textiles) can provide a well conducted millimeter-wave (mm-wave) signal with relatively low losses. In one or more embodiments of the invention, a periodic director pattern is drawn onto a surface with either a pen or an inkjet printer. The quality of the pattern is not critical as directed mm-wave links have tremendous signal-to-noise ratio (SNR) margins. This is the first known example of printing an mm-wave circuit onto a substrate or material.

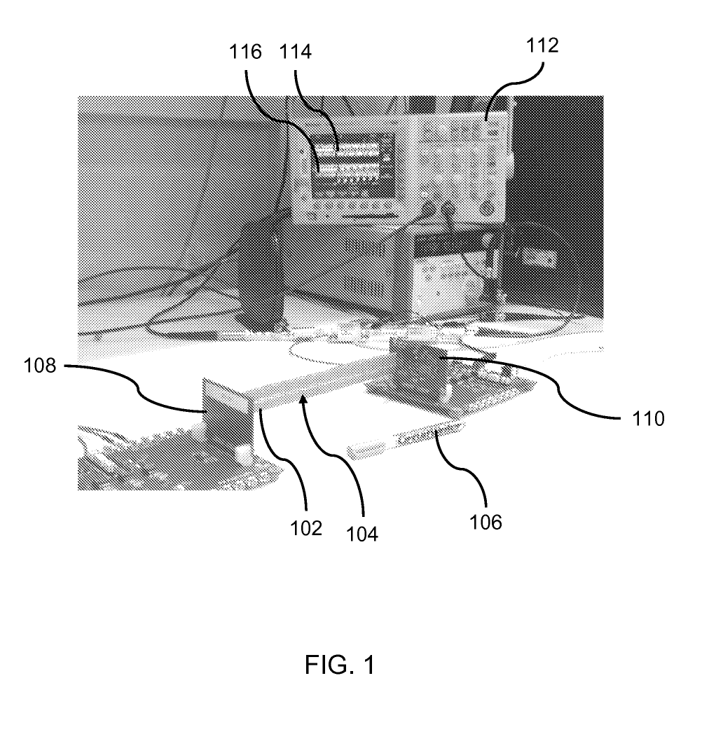

FIGS. 1-4 illustrate a data link, comprising a substrate and an ink structure (e.g., structure consisting essentially of ink) printed and/or marked on the substrate, wherein the ink structure and/or the substrate directs EM radiation, one or more electric fields or signals, one or more magnetic fields or signals, one or more electromagnetic fields, and/or one or more electromagnetic waves or signals between two locations, according to one or more embodiments of the invention.

FIG. 1 shows an experimental setup illustrating the propagation of a signal across a periodic director comprising a series of ink-based metallic lines or strips. The series of ink-based metallic lines or strips 104 are drawn or printed onto a non-conductive substrate 102 (in this instance a piece of cardboard) using a pen (CircuitWriter™ pen) or inkjet printer containing metallic ink 106 (CircuitWriter™ ink). A signal is generated and transmitted from a transmitter 108 to a receiver 110 across the series of ink-based metallic lines or strips 104. An oscilloscope 112 measuring the signal shows that the signal is successfully directed by and propagated across or follows the series of ink-based metallic lines or strips 104, displaying an input waveform 114 on the top and an output waveform 116 on the bottom. For the section of cardboard, the overall link loss was −8.6 dB according to the internal EVM meter in the software. In this experiment, a Hittite ADI 60 GHz transceiver evaluation kit was used to implement the datalink. However, any general (e.g., mm-wave) transmitter and receiver could be used.

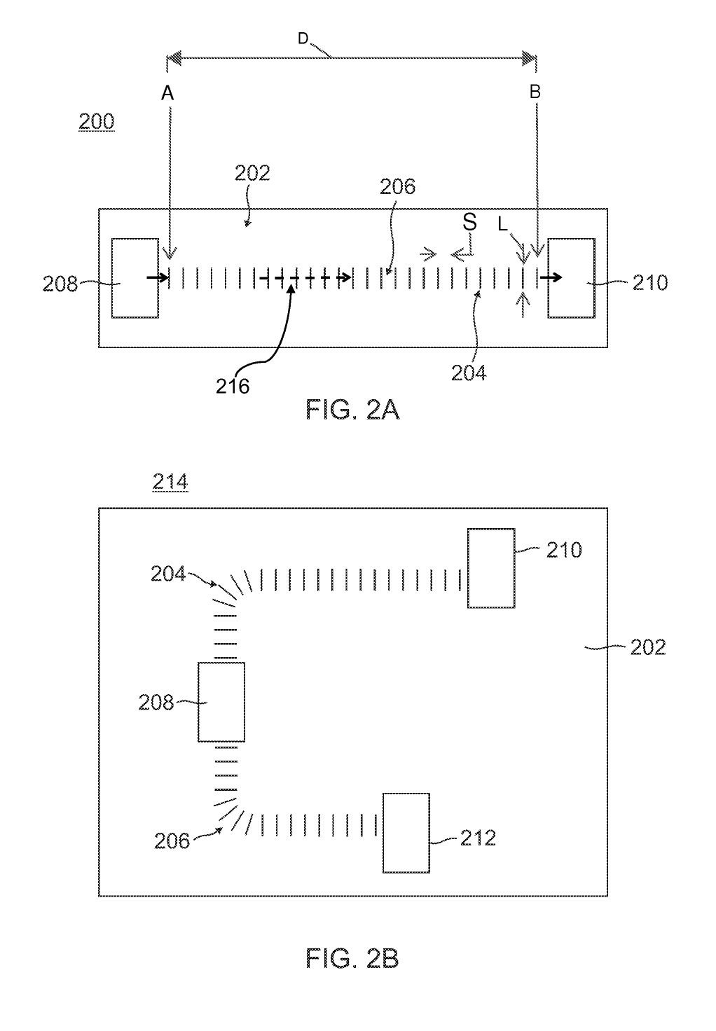

FIG. 2A is an illustration of a system 200 comprising a transmitter 208 and a receiver 210 at respective ends of a periodic director comprising a series of ink-based metallic lines or strips 204. A signal generated and transmitted from the transmitter 208 is received by the metallic lines or strips 204 and propagates along or across the metallic lines or strips 204 to the receiver 210 at the other end. The transmitter 208 can comprise an antenna for transmitting the signal to the metallic strips 204 (e.g., using near field transmission), and the receiver 210 can comprise an antenna for receiving the signal from the metallic strips 204 (e.g., using near field transmission). The metallic lines or strips 204 having length L are printed on a non-conductive substrate 202 and positioned with gaps/spaces 206 in between such that they do not touch and with a separation distance S between each periodic coupling structure or strip 206 being within one wavelength (e.g., a few mm) of the signal being propagated or within a range of the near field coupling of the EM signal between the strips 204. In this embodiment, the series of metallic lines or strips 204 form a straight line and are generally parallel to each other.

FIG. 2B shows a system 214 according to another embodiment, comprising a transmitter 208 and a plurality of receivers 210, 212 at respective ends of the periodic director comprising series of ink-based metallic lines, strips or structures 204. A signal generated from the transmitter 208 that is placed near or on the series of ink-based metallic lines 204 propagates along or across the metallic lines, strips, or structures 204 to the plurality of receivers 210, 212. Here, the series of metallic lines, strips, or structures 204 are not in a straight line but rather curve around on the non-conductive substrate 202. Additionally, the metallic lines, strips, or structures 204 may not parallel to each other at sections where they curve, though they are still positioned such that they do not touch one another and with the spacing for near field coupling.

Also shown is the propagation direction 216 of the signal.

In the periodic director embodiment, ink-based metallic lines or strips are positioned such that a signal propagates along, across, or between, or is guided by, the series of ink-based metallic lines or strips using near field transmission or coupling. In particular embodiments, the signal propagates along the series of ink-based metallic lines or strips in a direction substantially perpendicular to a lengthwise dimension of each ink-based metallic line or strip. The electric field of the signal can be a transverse electric (TE) mode Additionally, in one or more periodic director embodiments, the ink-based metallic lines or strips are spaced such that they do not touch one another. Thus, in one or more embodiments, the signal is not transmitted through a cable, wire, or conductive pathway.

A metallic ink can be used to print or attach the ink-based metallic lines, strips, or structures on the non-conductive substrate. In one or more embodiments, the metallic ink can comprise a liquid or paste that comprises small metallic or metal particles in the form of a mixture, solution or suspension, for example silver microparticles with an acrylic binder. However, any type of metallic or metal particles may be used, including but not limited to aluminum, bronze, copper, zinc, nickel, gold, and silver. In one instance, the metallic particles are less than 20 microns in diameter. In another instance, the metallic particles are less than 10 microns in diameter. As long as it is sufficient for transmitting signals, the metallic content of the ink may be further adjusted depending on a number of factors (e.g. desired drying characteristics, setting rate, conductivity, signal transmission quality, data rate, power consumption, cost). The ink may be printed, attached, injected, or soaked into the non-conductive substrate in different states (e.g. on top, under the surface, embedded within) depending on various factors, such as the porosity of the substrate, hydrophobicity/hydrophilicity of the substrate, size of the metallic particles, etc. The printed metallic lines or structures can be air-dried or cured such that they are attached to the non-conductive substrate.

Possible Modifications

Typically, the signal is a millimeter-wave (mm-wave) or a microwave, but electromagnetic waves or radio waves of other wavelengths can also be used, such as terahertz waves. The system typically comprises a non-conductive or insulating substrate, but other substrates can also be used. While the structure can comprise a periodic director, periodic near field director comprising one or more periodic coupling structures or series of ink-based metallic lines or strips printed on the non-conductive substrate, other structures, such as a circuit, circuits, or circuitry (e.g., one or more integrated circuits, planar or two dimensional circuits such as mm or microwave circuits that can comprise components), antennas, Yagi-Uda antennas, Y junctions, Y splitters, and hybrids, can also be printed/fabricated.

Propagation of the signal may be changed and fine-tuned by varying the dimensions (e.g., lengths, spacing) of the metallic lines or strips or structures. The length of the lines can be changed to change propagation or tune the structure to propagate the desired frequency of waves. Optimal signal propagation occurs when the metallic lines and/or length of the lines are well balanced or tuned (like a resonator or circuit that is impedance matched)—the metallic lines or strips may act as an inductor if they are too long and conversely may act as a capacitor if they are too short. In certain embodiments, the ink-based metallic lines or strips have substantially similar lengths. The length of the strips 204 is typically one or more millimeters (e.g., 1 mm) and spacing between strips 204 is typically also one or more mm (e.g., 1.125 mm) to propagate a signal having mm wavelengths. However, the specific dimensions will vary depending on the material of substrate (e.g., the substrate's dielectric constant) and the wavelength of the signal being propagated. For example, the length and spacing of the strips can be of the order of micrometers. In one or more other embodiments, the series of metallic lines or strips comprises a straight segment of generally parallel metallic lines.

The non-conductive substrate or insulator may be any substrate that does not conduct electricity or has very low conductivity, including but not limited to fabric, cloth, wood, plastic, rubber, epoxy, ceramic, glass, leather, composite, paper, concrete, textile, paint, plaster, wall material, or carpet. In one or more embodiments, the non-conductive substrate is a flexible substrate. For example, the non-conductive substrate may be part of clothing (e.g. shirt, pants, socks, hat, scarf), footwear (e.g. shoes, sandals), and/or accessories (e.g. purse, bag, umbrella, wallet) worn or carried by a person. The non-conductive substrate may also be the skin of a person, with the series of metallic lines printed on the skin as a tattoo. The metallic lines may also be printed onto a sticker or substrate with an adhesive backing that can be subsequently attached to a person or object. In one or more embodiments, the non-conductive substrate is part of a wall, flooring, and/or ceiling of a building or structure.

Examples of Applications

One or more embodiments of this technology may be used for communication links, for example, between mobile devices, computers, displays, modules on spacecraft, landers, and rovers. Dielectric waveguide technology offers a low weight, size, and power approach to Gigabit per second (Gb/s) interconnects. These data-links also offer improved reliability and reduced packaging complexity as they do not depend on physical contact, which allows for added vibration/stress immunity.

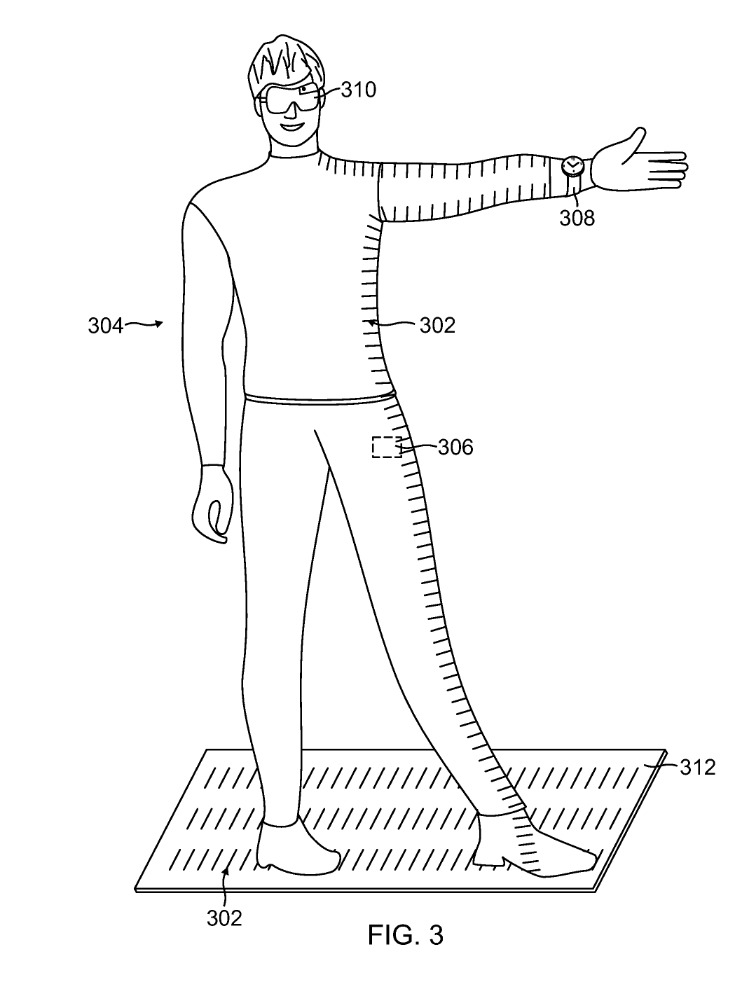

FIG. 3 is an illustration of a system for propagating a signal where a periodic director comprising a series of ink-based metallic lines or strips 302 are printed on a person's clothing 304 as well as on the floor 312. A cellular phone 306 comprising a transceiver is located in a pocket of the person's pants. Data signals can be propagated along, across, or between, or guided by, the metallic lines or strips 302 between various transceivers or devices worn or carried by the person, such as a cellular phone 306, electronic watch 308 (e.g. Apple Watch™), and smart glasses 310 (e.g. Google Glass™). Signals can also be propagated to/from the floor 312 by the periodic director comprising metallic lines or strips 302 printed on the floor and the person's shoes. The periodic director printed on the floor 312 can direct the signal to or from other devices, such as a television, display, computer, mobile device, cell phone, e.g., on one or more other persons.

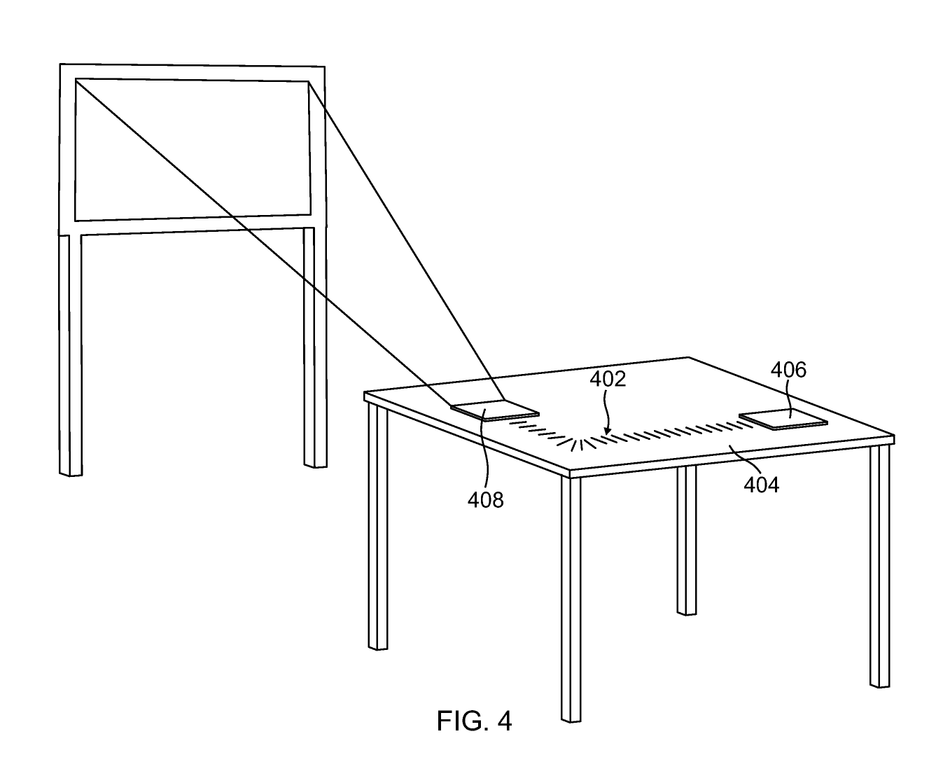

FIG. 4 is an illustration of a system for propagating a signal where a periodic director comprising a series of ink-based metallic lines or strips 402 are printed on a table 404. A mobile device 406, comprising a transceiver, is placed near the series of metallic lines 402. Signals containing video, image, and/or text data are propagated along, across, or between the metallic lines or strips 402 to the transceiver in a projector 408, so that the projector 408 can project the video, image, and/or text data to a projection screen.

In one or more embodiments, the system further comprises a transmitter that generates a signal that is transmitted (e.g., using antenna) to the periodic director comprising a series of ink-based metallic lines or strips and a receiver that receives (e.g., using antenna) the signal directed along the periodic director. In other embodiments, the system comprises one or more of a transmitter, receiver, and/or transceiver. Importantly, the transmitter, receiver, and/or transceiver do not need to be in electrical and/or physical contact with the series of ink-based metallic lines or strips since the signal is radiatively transmitted or wave based, e.g., via near field coupling. Instead, the transmitter, receiver, and/or transceiver may be placed on or near the series of ink-based metallic lines or strips such that the signal is wirelessly transmitted between the antenna of the transceiver and the metal strips of the periodic director.

The transmitter can comprise a voltage-controlled oscillator (VCO) for generating an EM carrier signal (e.g. RF or mm wave) and a modulator for modulating the EM carrier signal with data. The modulator can modulate the EM carrier signal with the data using modulating schemes such as amplitude shift keying (ASK) modulation, using a pair of on-off switches. The transmitter can further comprise an antenna for transmitting the modulated EM carrier signal to the periodic director [1].

The receiver can comprise an antenna for receiving the EM carrier signal from the periodic director, a low-noise amplifier (LNA) to amplify the received EM carrier signal, and a demodulator to enable the data to be read [1].

Process Steps

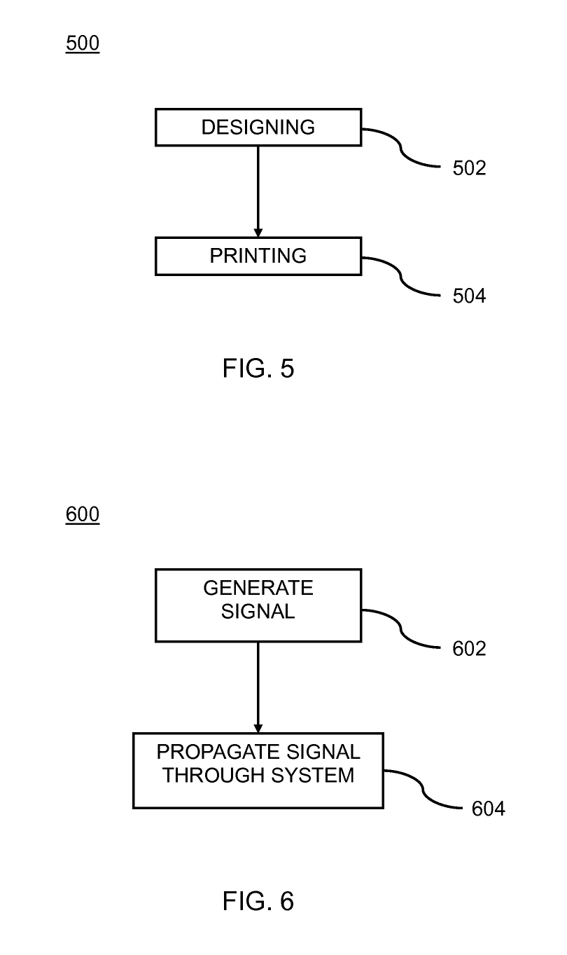

FIG. 5 illustrates a method 500 of fabricating a data link according to one or more embodiments.

Block 502 represents designing a structure, pattern, or signal carrying device that can be printed or patterned on a substrate or surface (e.g., non conductive surface or non-conductive substrate) using ink. The structure can carry EM radiation or one or more electric and/or magnetic and/or electromagnetic signals, fields, or waves (e.g., mm-wave) across the surface. The structure can be scaled to carry the waves (e.g., mm-scale). The step can comprise selecting the ink's composition (including metal) and/or the structure's or pattern's dimensions in order to direct the radiation, the one or more waves, or one or more signals (e.g. Radio Frequency (RF) or RF power) between two locations or places, e.g., between a first location A and a second location B (e.g., as illustrated in FIG. 2A). The structure can be designed on a computer, taking into account one or more factors, such as the wavelength of the waves, the composition of the substrate (e.g., dielectric constant), and data to be transmitted. In one or more embodiments, software for solving Electromagnetic field equations can be used. The structure design can be outputted as a data file to a processor in a printer.

In one or more embodiments of the invention, the structure can comprise one or more circuits, portions (e.g., linear portions), segments, sticks, lines 204, or strips, e.g., positioned and dimensioned to form a resonator and/or one or more directors in an antenna (e.g., Yagi or Yagi-Uda antenna) for the waves. For example, the lines or strips 204 in the structure can ring and/or couple (e.g., through near field coupling) the electric and/or magnetic field of the wave to the next line or strip 204 in the series, e.g., such that the field jumps along or each line 204 or strip resonates one by one. For example, the structure (e.g., comprising lines 204) can comprise a resonator having the properties of a resonant circuit (e.g., LC circuit comprising an inductor L and Capacitor C in parallel or series), wherein the resonance of the circuit or resonator can be tuned to the right or desired frequency of the wave to be directed. For example, the length L and/or spacing S of the lines or strips 204 can be changed to change propagation or tune the structure to propagate the desired frequency of the waves. The length and spacing of the lines 204 can be such that the waves are transmitted or propagated by near field transmission or propagation between the lines 204 or such that each line 204 is in the near field region of adjacent or next neighboring lines 204.

In one or more embodiments of the invention, the structure can comprise a periodic near field coupler or director (PNFD) (e.g., transmitting EM radiation as defined in [1]) or using near field technology to transmit EM fields. The structure can comprise one or more ink periodic coupling structures, or a series of ink-based metallic lines, strips 204, linear portions, or segments, on an (e.g., non-conductive) substrate or surface. The ink-based metallic lines can be spaced such that they do not touch one another and with dimensions such that the EM radiation or waves follows, or is transmitted between, the line of strips, e.g., using near field transmission or coupling. The ink-based metallic lines can be positioned such that a signal propagates along/across/between the series of ink-based metallic lines. The signal can propagate along/across/between the series of ink-based metallic lines in a direction substantially perpendicular to a lengthwise dimension of each ink-based metallic line (e.g., the lengthwise direction dimension of the strips is substantially perpendicular to the signal propagation direction and the spacing of strips is within one wavelength of the signal).

The EM radiation or waves can comprise millimeter waves having a wavelength in a range of 1-10 mm, RF, microwaves, or terahertz radiation or waves having wavelengths corresponding to terahertz frequencies. However, the printed structure can work at any frequency. In one or more embodiments of the structure and printing method, frequencies below 1 GHz may not be practical because directors become too large to print.

The substrate can be a flexible and/or insulating substrate, e.g., comprising fabric, cloth, cardboard, wood, plastic, rubber, clothing, T-shirt, pants, ceramic, glass, leather, composite, paper, concrete, textile, and/or carpet.

The EM radiation or waves can carry data comprising voice, text, video, image, and/or internet data between the two locations and can direct the EM radiation or waves carrying data between one or more devices selected from one or more mobile devices (e.g., cell phone, tablet, smartphone, tablet), a wearable device, a display, and a computer.

Block 504 represents printing or patterning the structure on the substrate or surface, e.g. using the printer (e.g., inkjet printer), according to structure design provided in Block 502. The step can comprise patterning a surface to carry the wave(s). The printer can use a processor to control the printing according to the structure design.

In one or more embodiments, the structure (e.g., series of ink-based metallic lines) is printed on the (e.g., non-conductive) substrate or surface using a pen (e.g., CAIG CircuitWriter™ pen) or an ink jet printer containing metallic ink. In one or more embodiments, the pen can comprise a CAIG CircuitWriter™ pen containing ink having composition and properties in the data sheet [2]. In one or more embodiments, the pen can comprise metallic ink as used in arts and crafts. In one or more embodiments, the ink used to print the structure can comprise, consist essentially of, or be conductive ink, metallic ink, the ink in [2], and/or or the ink having the composition and/or properties described in the data sheet [2] or equivalent thereof. In one or more embodiments, the ink can comprise metal, e.g., having a metal content and conductivity at least as high as the metal content and conductivity in [2]. In one or more embodiments, the printer can have an ink cartridge comprising and printing the ink used or contained in a pen, such as CAIG CircuitWriter™, or equivalent thereof. For example, in one or more embodiments of the invention, the structure can be printed with a printer, wherein the printer's ink cartridge can be emptied and ink from the pen (e.g., CircuitWriter™) can be put in the ink printer cartridge.

Other examples include Roland™, Mimaki™, Mutoh™, Epson™, and Hewlett-Packard™ printers.

The metallic lines may also be printed on a substrate by using a stamp or stencil with metallic ink or spray paint. Significantly, the amount of time, work, and resources needed to print ink-based metallic lines is much less compared to methods that require the creation of a masking pattern and etching away of excess metals. A protective coating may further be applied over the printed ink-based metallic lines to protect them from scratching and smudging.

In one or more embodiments, the substrate and the structure and composition of the structure can be such that the data link has a loss of no more than −8.6 dB (e.g., for a half meter length).

In one or more embodiments of the invention, the substrate, the surface, the structure (e.g., dimensions of the structure), and composition of the structure, can be such that the structure directs an electric and/or magnetic and/or electromagnetic wave, e.g., carrying data, between a first location A and a second location B (e.g., as indicated in FIG. 2A) with a loss of no more than −8.6 dB (e.g., when the first location and second location are separated by a distance D of at least 8 inches or at least half a meter). In one or more embodiments, the structure directs an electric and/or magnetic and/or electromagnetic wave between a first location and a second location separated by a distance D of at least ½ a foot, at least 1 foot, at least 2 feet, at least 3 feet, at least 6 feet, at least 8 feet, at least 20 feet, at least 10 centimeters, at least 25 centimeters, at least 0.5 meters, at least one meter, at least two meters, at least 3 meters, at least 4 meters, at least 5 meters, at least 7 meters, at least 10 meters, at least 15 meters, or at least 20 meters, for example. The wave can be transmitted between the first location A and a transmitter or receiver in a first device adjacent the first location A, the wave can be transmitted between the second location B and a transmitter or receiver in a second device adjacent the second location B, and the structure can direct the wave carrying the data between the first location A and second location B and between the first device and the second device across the distance D. The first and second devices can comprise a mobile phone, display, or computer, for example. The transmitter or receiver in the first device can be within the near field range of the line 204 at the first location A and the transmitter or receiver in the second device can be within the near field range of the line 204 at the second location B. Thus, one or more embodiments allow communication between the first and second devices.

FIG. 6 illustrates a method for propagating electric, magnetic, and/or EM waves or radiation (e.g., a signal), e.g. using the data link fabricated in FIG. 5. The method 600 comprises step 602 of generating and/or transmitting a signal/EM radiation/waves to an ink-based metallic structure printed on the non-substrate, and step 604 of propagating the signal or EM radiation or waves, or allowing the signal/EM radiation/waves to be directed or guided by the structure between two locations. In one or more embodiments, the structure can provide a non contact (e.g., non-electrical contact) wave based data link directing or carrying EM radiation/waves between two locations. The signal can be propagated through a system comprising a non-conductive substrate or surface and a series of ink-based metallic lines printed on the non-conductive substrate, wherein the signal propagates along/across/between the series of ink-based metallic lines.

In one or more embodiments of the invention, a docking system can be provided using the data link that enables users to share or talk to one another (e.g., as an alternative to Bluetooth technology, e.g., carrying more data than Bluetooth) using the EM radiation or waves carried by the structure.

In one or more embodiments of the invention, the printing or patterning can provide or fabricate the signal carrying device without a cable, or the signal carrying device that conducts, propagates, directs, guides, or transmits the signal without a cable. In one or more embodiments of the invention, the printing or patterning can provide or fabricate the signal carrying device that conducts, propagates, directs, guides, or transmits the signal but not through a physical structure or cable.

The propagated signal can be modulated using any modulation (Amplitude shift keying (ASK), Quadrature Amplitude Modulation (QAM), Code Division Multiple Access (CDMA), Orthogonal Frequency Division Multiplexing (OFDM) or any/all standard(s), e.g., Bluetooth, BT, Worldwide Interoperability for Microwave Access (WiMaX), Zigbee, 802.11s . . . etc.

In one or more embodiments of the invention, the data rate and power consumption of the data link can be completely dependent on what transmitter and receiver are used (e.g., any operating in the mm-wave regime).

Advantages and Improvements

Signals such as mm-waves can be used to wirelessly transmit data to other transceivers. However, these wireless signals are generally transmitted in all directions (omnidirectional), resulting in a significant portion of their power being wasted and lost. Typically, mm-wave transmitters have power efficiencies of 1-10%. Therefore, the data transfer rate of wireless signals can be low in relation to the amount of power expended.

In contrast, one or more embodiments of the present invention provide data links that can focus wireless signals or RF power towards specific directions and transceivers, allowing for more efficient and effective power usage. In one or more embodiments, the signal is generated and transmitted by a transmitter not in electrical contact with the structure or series of ink-based metallic lines. In certain embodiments, the generated signal is confined to being propagated along/across/between the series of ink-based metallic lines. This can help focus the signal to a smaller area such that it does not interfere or affect instruments/other objects nearby.

Thus, one or more embodiments of the invention enable lower powered electronics and/or higher data transfer rates. In certain implementations (e.g., one or more embodiments of the periodic director), the present invention can have [[has]] a 2-3 orders of magnitude better or 2-3 times higher data transfer rate than wireless transmission, omnidirectional wireless transmission, or conventional wireless signal transmittance. Thus, Transmitting signals along periodic structures such as metallic lines printed with metallic ink can be more cost effective and power effective than using cables and wires.

Another advantage of one or more embodiments of the present invention is that the series of metallic lines is not limited to a straight line or direction (see, e.g. FIG. 2A) and can, for example, curve and/or wrap around the non-conductive substrate (see, e.g. FIG. 2B). Thus, there is a lot of flexibility in the overall path of the metallic lines, which can also be positioned at corners and angles. For example, the series of metallic lines may be printed on a path going from the inside to the outside of a piece of clothing or from the top to the bottom of a table. This way, signals can be propagated between a transmitter and receiver that are not in “line-of-sight” of each other. In contrast, techniques such as optical communication techniques (e.g. infrared, laser beams) require a “line-of-sight” for transmittance. Furthermore, the metallic lines are conformal and can easily be printed on an uneven surfaces (e.g. fabric).

### REFERENCES

The following references are incorporated by reference herein.
[1] International Application Number PCT/US2011/065576 published as International Publication No. WO 2012/083213, entitled “PERIODIC NEAR FIELD DIRECTORS (PNFD) FOR SHORT RANGE MILLIMETER-WAVE-WIRELESS-INTERCONNECT (M2W2-INTERCONNECT)” by Chang et. al.
[2] CAIG Laboratories Data Sheet for CircuitWriter CW100L liquid conductive ink, http://store.caig.com/s.nl/sc.2/category.174/.f.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A data link, comprising:
a substrate; and
an ink structure printed and/or marked on the substrate, wherein the structure directs an electric and/or magnetic and/or electromagnetic wave between a first location and a second location.

2. The data link of claim 1, wherein the structure comprises a periodic director.

3. The data link of claim 1, wherein the wave comprises a millimeter wave having a wavelength in a range of 1-10 mm.

4. The data link of claim 1, wherein the wave comprises a microwave or wave having a Terahertz frequency.

5. The data link of claim 1, wherein the substrate is an insulating substrate.

6. The data link of claim 1, wherein the substrate is a flexible substrate.

7. The data link of claim 1, wherein the substrate comprises at least one material selected from a fabric, cloth, clothing, paint, plaster, cardboard, wood, plastic, rubber, ceramic, glass, leather, composite, paper, concrete, textile, and carpet.

8. The data link of claim 1, wherein:
the structure receives the wave from a transmitting antenna at the first location, the transmitting antenna transmitting the wave comprising data to the structure; and
the structure directs and transmits the wave carrying the data to a receiving antenna at the second location.

9. The data link of claim 8, wherein the structure directs the wave carrying the data comprising voice, text, video, image, and/or internet data between the first and second locations.

10. The data link of claim 9, wherein the transmitter and receiver are in one or more devices selected from one or more mobile devices, a display, and a computer.

11. The data link of claim 1, wherein the ink comprises a composition and the structure comprises one or more dimensions suitable to direct the wave comprising data.

12. The data link of claim 1, wherein the ink comprises metal.

13. The data link of claim 1, wherein the ink is printed using an ink printer comprising a processor.

14. A method for propagating an electric, magnetic, and/or electromagnetic wave comprising:
transmitting an electric and/or magnetic and/or electromagnetic wave to an ink structure printed on the substrate, wherein the structure directs the wave between two locations.

15. A method for fabricating a data link, comprising:
printing a structure on a substrate using ink from an ink printer comprising a processor, wherein the ink has a composition comprising metal and the structure is dimensioned to direct an electric and/or magnetic and/or electromagnetic wave between a first location and a second location.

16. The method of claim 15, wherein the structure comprises a periodic director.

17. The method of claim 15, wherein the wave comprises a millimeter wave having a wavelength in a range of 1-10 mm, a microwave, or a wave having a Terahertz frequency.

18. The method of claim 15, wherein the substrate is a flexible and insulating substrate.

19. The method of claim 15, wherein the substrate comprises at least one material selected from a fabric, cloth, clothing, cardboard, wood, plastic, rubber, ceramic, glass, leather, composite, paper, concrete, textile, paint, plaster, and carpet.

20. The method of claim 15, wherein the structure directs the wave carrying data comprising voice, text, video, image, and/or internet data between a transmitter at the first location and a receiver at the second location, wherein the transmitter and receiver are in one or more devices selected from one or more mobile devices, a display, and a computer.
